(19) United States
(12) Patent Application Publication
(10) Pub. No.: US 2014/0009934 A1
(43) Pub. Date: Jan. 9, 2014

(54) ILLUMINATING DEVICE AND METHOD OF FABRICATING THE ILLUMINATING DEVICE

(71) Applicants: Ming-Chih Huang, New Taipei City (TW); Jia-Yi Juang, New Taipei City (TW); Chun-Heng Ou, New Taipei City (TW)

(72) Inventors: Ming-Chih Huang, New Taipei City (TW); Jia-Yi Juang, New Taipei City (TW); Chun-Heng Ou, New Taipei City (TW)

(73) Assignees: KINPO ELECTRONICS, INC., New Taipei City (TW); Cal-Comp Electronics & Communications Company Limited, New Taipei City (TW)

(21) Appl. No.: 13/615,629

(22) Filed: Sep. 14, 2012

(30) Foreign Application Priority Data
Jul. 6, 2012 (TW) 101124443

(51) Int. Cl. F21V 5/04; F21V 17/00; F21V 13/02; F21V 17/02; F21V 29/00

(52) U.S. Cl. 362/235; 362/311.01; 29/428; 29/825

(57) ABSTRACT

An illuminating device and method of fabricating the illuminating device are provided. The illuminating device includes a base, a cover, a light source circuit board, a lens and a circle. The base has a circuit board accommodating recess. The cover is assembled to the base and located in the circuit board accommodating recess. The cover has a lens accommodating recess and a first fixing structure located at opposite sides. The light source circuit board is disposed in the circuit board accommodating recess and located between the cover and the base. The light source circuit board has a second fixing structure inserted with the first fixing structure to assemble the light source circuit board with the cover. The lens is disposed in the lens accommodating recess. The circle encircles an edge of the lens and fixes to the base.

### CROSS-REFERENCE TO RELATED APPLICATION

This application claims the priority benefit of Taiwan application serial no. 101124443, filed on Jul. 6, 2012. The entirety of the above-mentioned patent application is hereby incorporated by reference herein and made a part of this specification.

### TECHNICAL FIELD

The disclosure relates to a device and a method of fabricating the device, and particularly relates to an illuminating device and a method of fabricating the illuminating device.

### BACKGROUND

A light-emitting diode is a semiconductor device. A material of light-emitting chips of the light-emitting diode primarily includes compounds of chemical elements selected from groups III-V, such as gallium phosphide (GaP) or gallium arsenide (GaAs). The light emitting principle is to convert electric energy into light energy. Specifically, the light-emitting diode applies an electric current to a compound semiconductor, such that redundant energy is released in the form of light through the combination of electrons and electron holes. Since luminance of the light-emitting diode is not caused by thermal emission or electric discharge, the lifetime of the light-emitting diode may be more than 100,000 hours. Moreover, the light-emitting diode has the advantages of quick response speed, compact size, low power consumption, low pollution, high reliability, capability for industrial production, etc. Therefore, the application of light-emitting diode is fairly extensive, such as light-emitting diodes of mega-size outdoor display boards, traffic lights, cell phones, scanners and fax machines, as well as lamps using light-emitting diode, and so forth.

In most cases of the conventional design of lamps using light-emitting diode, a screw is constantly used to penetrate through a light source circuit board to lock into a lamp base. Moreover, for the purpose of structural strength and certification of security standards, metal screws are frequently used. However, although using a metal screw helps to pass and obtain the certification of the security standard of the United States, when the light-emitting diode takes a high voltage test of the European Security Standards, the light-emitting diode is applied with a high voltage up to 4 kilo-volts. Given that a lamp using the light-emitting diode is not designed with a protective circuit, such a high voltage is prone to damage the light-emitting diode.

### SUMMARY

The disclosure provides an illuminating device, a configuration of which is different from a configuration of conventional illuminating devices.

The disclosure provides a method of fabricating an illuminating device, fabrication of which is not exactly identical to fabrication of conventional illuminating devices.

The disclosure provides an illuminating device, including a base, a cover, a light source circuit board, a lens, and a circle. The base has a circuit board accommodating recess, and the cover is assembled to the base and located in the circuit board accommodating recess, wherein the cover has a lens accommodating recess and a first fixing structure located at opposite sides. The light source circuit board is disposed in the circuit board accommodating recess and located between the cover and the base, wherein the light source circuit board has a second fixing structure inserted with the first fixing structure to fix the light source circuit board and the cover together. The lens is disposed in the lens accommodating recess. The circle encircles an edge of the lens and fixes to the base.

The disclosure also provides a method of fabricating an illuminating device, including at least the following: providing a cover and a light source circuit board and inserting a first fixing structure of the cover with a second fixing structure of the light source circuit board to assemble the first fixing structure of the cover and the second fixing structure of the light source circuit board together; providing a lens, and disposing the lens in a lens accommodating recess of the cover; providing a base, and disposing the lens, the cover, and the light source circuit board in a circuit board accommodating recess of the base; and providing a circle, making the circle encircle an edge of the lens and fixing to the base, such that the lens, the cover, and the light source circuit board are fixed to the circuit board accommodating recess of the base.

In view of the above, in the illuminating device and the method of fabricating the illuminating device according to the disclosure, the fixing structures that are capable of being inserted with each other are disposed on the cover and the light source circuit board, such that the firmness when the cover and the light source circuit board are assembled together is improved. In addition, responsive to the disposition of the fixing structures, the fabrication is adaptively adjusted in the method of fabricating the illuminating device.

In order to make the aforementioned features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is an exploded schematic view of an illuminating device according to an embodiment of the disclosure.

FIG. 2 is a schematic view of a cover of the illuminating device of FIG. 1 from another perspective.

FIG. 3 is a cross-sectional view of the illuminating device of FIG. 1.

FIG. 4 is a top view of the cover of FIG. 2.

FIG. 5 is a flowchart of fabrication of the illuminating device of FIG. 1.

### DETAILED DESCRIPTION OF DISCLOSED EMBODIMENTS

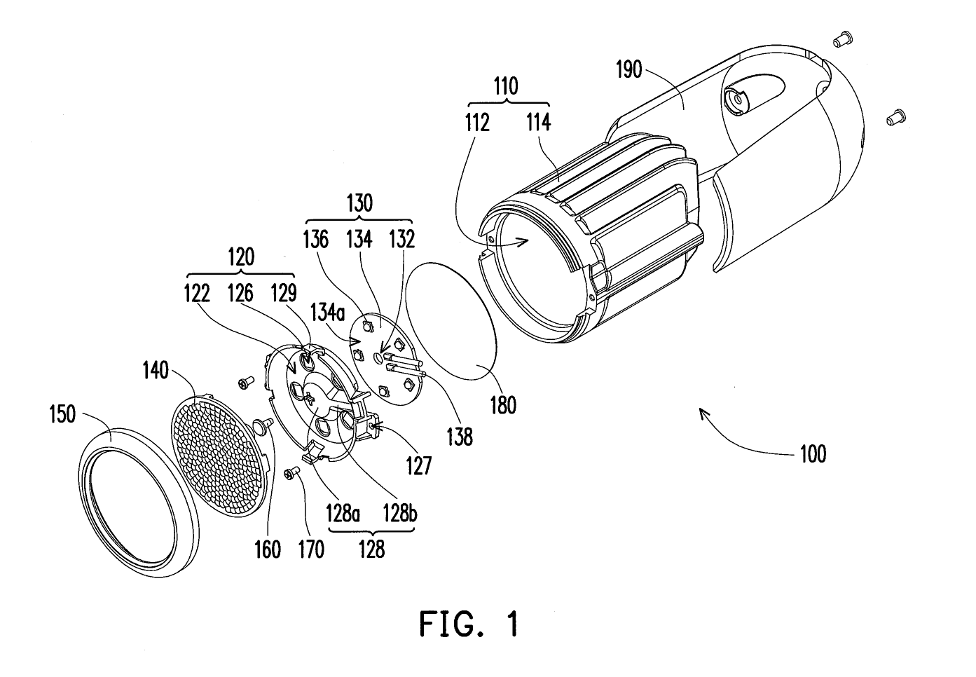

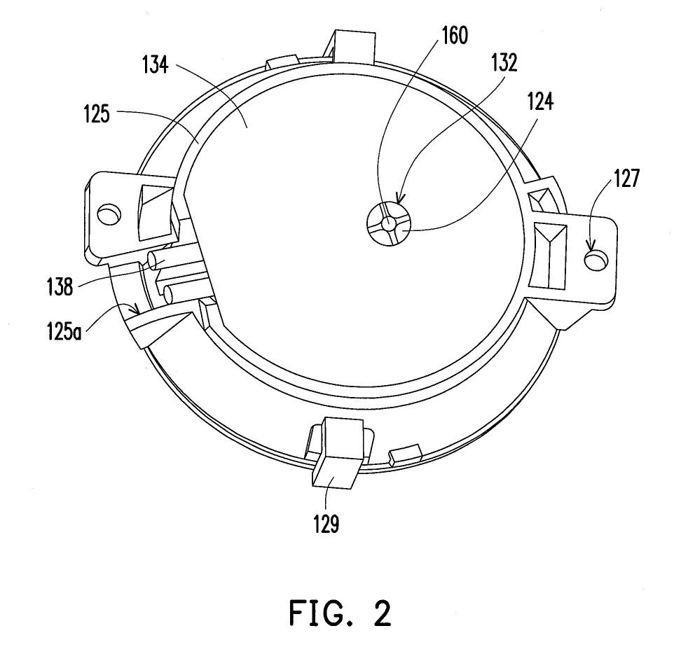

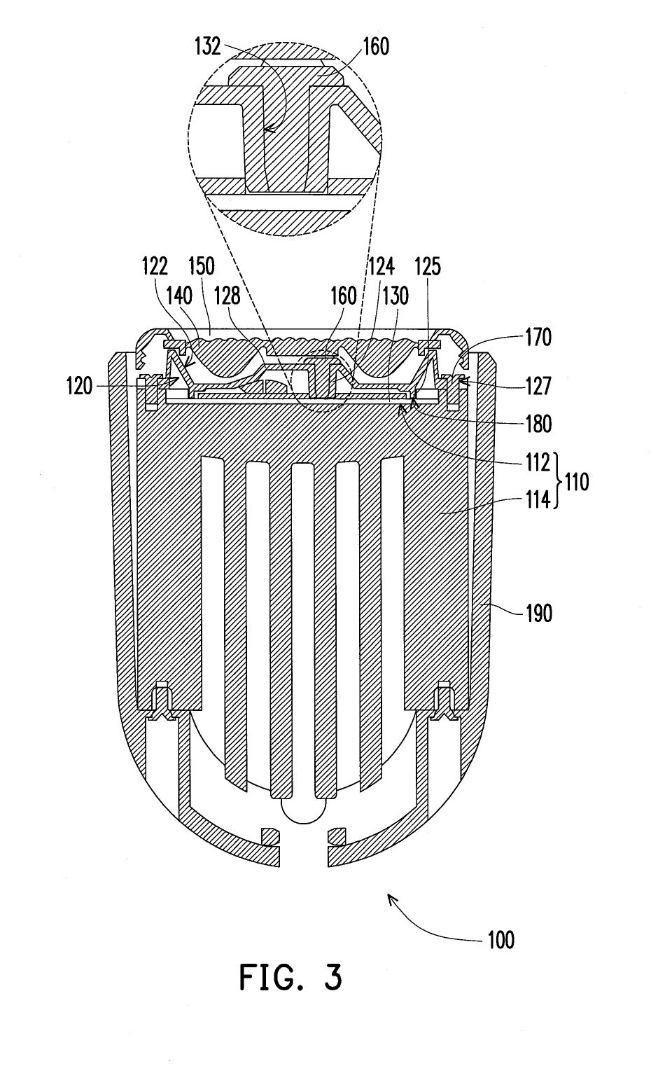

FIG. 1 is an exploded schematic view of an illuminating device according to an embodiment of the disclosure. FIG. 2 is a schematic view of a cover of the illuminating device of FIG. 1 from another perspective. FIG. 3 is a cross-sectional view of the illuminating device of FIG. 1. Referring to FIGS. 1, 2, and 3 together, an illuminating apparatus 100 includes a base 110, a cover 120, a light source circuit board 130, a lens 140, and a circle 150. The base 110 has a circuit board accommodating recess 112, and the cover 120 is assembled to the base 110 and located in the circuit board accommodating recess 112, wherein the cover 120 has a lens accommodating recess 122 and a first fixing structure 124 located at opposite sides. The light source circuit board 130 is disposed in the circuit board accommodating recess 112 and located between the cover 120 and the base 110, wherein the light source circuit board 130 has a second fixing structure 132 inserted with the first fixing structure 124 to fix the light source circuit board 130 and the cover 120 together. The lens 140 is disposed in the lens accommodating recess 122. The circle 150 encircles an edge of the lens 140 and fixes to the base 110. The second fixing structure 132 of the light source circuit board 130 of the illuminating device 100 is inserted with the first fixing structure 124 of the cover 120, such that the light source circuit board 130 and the cover 120 are stably fixed together without using a screw.

The first fixing structure 124 may be a through-hole, whereas the second fixing structure 132 may be a bush correspondingly latched into the through-hole, such that the second fixing structure 132 and the cover 120 are assembled together. The bush described herein may be formed of at least two locking hooks. In addition, to increase assembling firmness between the light source circuit board 130 and the cover 120, the illuminating device 100 may further include a fixing plug 160 penetrating into the bush, which keeps the bush being, for example, two locking hooks in a open state in the through-whole, such that the light source circuit board 130 is prevented from moving or rotating relative to the cover 120.

Forms and locations of the first fixing structure 124 and the second fixing structure 132 are not limited to the embodiment described herein. Moreover, a number of the locking hooks is not limited to the disclosure of the embodiment described above. In another embodiment, a bush may be formed on the light source circuit board 130, whereas a through-whole may be formed on the cover 120. Or alternatively, in still another embodiment, it may be that the second fixing structure 132 is a pillar, whereas the first fixing structure 124 may be a depression. Moreover, the number of the locking hooks for forming a bush may be three, four, or more, based on practical needs. It can be known that the embodying configurations of the first fixing structure 124 and the second fixing structure 132 should be an art that people having ordinary skill in the art may modify based on practical needs.

Moreover, the second fixing structure 132 and the cover 120 are integrally formed, and a material thereof is a non-conductive material. Usually, the cover 120 simultaneously contacts the light source circuit board 130 whose surface is disposed with a wire and a base 110 made of metal, wherein the cover 120 and the base 110 are usually combined by being locked together with a screw. To avoid a short circuit, the cover 120 is usually made of a non-conductive material. It should be noted that using a non-conductive material to fabricate the second fixing structure 132 allows an increased safety creepage distance of the illuminating device 100 in order to pass the high voltage test of the European Security Standards as well as prevent the light source circuit board 130 from being damaged by sudden high voltage. Thereby, the illuminating device 100 still maintains a normal function afterward.

Referring to FIG. 1, the light source circuit board 130 of the embodiment described above includes a circuit board 134 and a plurality of light-emitting diodes 136, wherein the second fixing structure 132 as a through-hole is disposed in the circuit board 134, and the light-emitting diodes 136 are disposed on a surface 134a of the circuit board 134 facing the lens 140. In addition, a shape of the circuit board 134 of the embodiment is approximately round, and the light-emitting diodes 136 are arranged along a circumferential direction of the circuit board 134.

Moreover, a bottom of the cover 120 facing the base 110 further includes a circular structure 125 surrounding outside of the light source circuit board 130. In the embodiment, when the cover 120 and the light source circuit board 130 are assembled together, the circular structure 125 encircles the circuit board 134, wherein although the first fixing structure 124 being inserted with the second fixing structure 132 has already fixed the circuit board 134 relative to the cover 120, a size of the circular structure 125 and a size of the circuit board 134 may be further matched to tightly fit the circular structure 125 and the circuit board 134 through close-fitting. Thereby, the assembling firmness between the light source circuit board 130 and the cover 120 is improved.

Although the embodiment is described above with the shape of the circuit board 134 being approximately round, people having ordinary skill in the art may modify the shape of the circuit board 134 based on practical needs. Correspondingly, a shape of the circular structure 125 may also be modified.

Referring to FIGS. 1 and 3, the cover 120 may further include a plurality of accommodating holes 126, the accommodating holes 126 being located in the lens accommodating recess 122, and the light-emitting diodes 136 are disposed correspondingly through the accommodating holes 126 to be located in the lens accommodating recess 122. Besides, a budge portion 128 may further be disposed in the lens accommodating recess 122 of the cover 120, the budge portion 128 budging toward the lens 140, the second fixing structure 132 being located at one side of the budge portion 128 away from the lens 140, and the accommodating holes 126 being disposed around the budge portion 128.

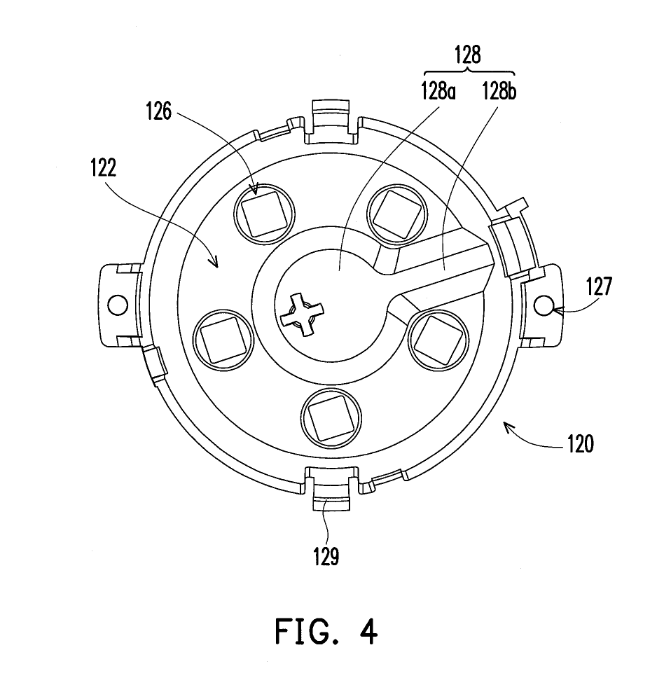

FIG. 4 is a top view of the circuit board of FIG. 2. Referring to FIGS. 1, 2, and 4 together, the budge portion 128 of the embodiment has an approximate key shape and, viewing from the top view of FIG. 4, the budge portion 128 has a round portion 128a and a rectangular portion 128b that are connected, wherein the round portion 128a is approximately located at central of the lens accommodating recess 122, whereas the rectangular portion 128b extends radially from the round portion 128a to a sidewall of an edge of the lens accommodating recess 122.

Referring to FIGS. 1, 2, and 3, the light source circuit board 130 further includes two wires 138 connecting to the circuit board 134, and the light-emitting diodes 136 are electrically connected with the wires 138 through the circuit board 134, and the wires 138 are contained in the budge portion 128. Viewing from the embodiment of FIG. 2, it can be seen that the circular structure 125 of the lens accommodating recess 122 of the cover 120 has an exit 125a connected with the budge portion 128, and the wires 138 extends outside through the exit 125a. The wires 138 are connected with an external power source. Simply put it, power for light emission of the light-emitting diodes 136 is supplied to the light-emitting diodes 136 from the external power source through the wires 138 and the circuit board 134 connected with the wires 138.

In an embodiment not shown here, the cover 120 may not have the budge portion 128. However, it can be known by people having ordinary skill in the art that since the wires 138 have a thickness, a corresponding configuration is to increase a height of the circular structure 125 located at the bottom of the cover 120, such that the wires 138 are allowed to be contained between the circuit board 134 and the cover 120 to avoid an issue that the wires 138 and the circuit board 134 are damaged or the cover 120 is deformed due to over-squeezing. It can be known that the budge portion 128 is configured in correspondence to the wires 138, but the budge portion 128 is not a required element.

In the embodiment of FIG. 1, the cover 120 may further include a plurality of elastic arm locking hooks 129, which are disposed on an edge of the cover 120 along a circumferential direction of the cover 120 to fasten the lens 140, and thereby the lens 140 is firmly assembled with the cover 120.

In addition, the illuminating device 100 may further include a plurality of fixing members 170, whereas the cover 120 has a plurality of fixing structures 127 located outside of the lens accommodating recess 122. In addition, the fixing structures 127 are openings, and the fixing members 170 penetrate through the fixing structures 127 to lock into the base 110.

In the embodiment of FIG. 1, the illuminating device 100 may further include a heat dissipation pad 180 disposed between the base 110 and the light source circuit board 130. In addition, the heat dissipation pad 180 is located in the circuit board accommodating recess 112. Disposition of the heat dissipation pad 180 may facilitate heat conduction from the light source circuit board 130 to the base 110 through the heat dissipation pad 180 to dissipate, thereby improving heat dissipation and elongate lifetime of the illuminating device 100. The heat dissipation pad 180 may be fixed between the base 110 and the light source circuit board 130 through a tight combination between the cover 120 and the base 110. In other words, when the cover 120 is dissembled from the base 110, the heat dissipation pad 180 may lose the mechanism fixing the heat dissipation pad 180 to the circuit board accommodating recess 112 of the base 110. To avoid losing the mechanism, the heat dissipation pad 180 may be adhered in the circuit board accommodating recess 112 of the base 110 with a heat dissipation paste. This way, when the cover 120 is dissembled from the base 110, the heat dissipation pad 180 is still adhered in the circuit board accommodating recess 112 of the base 110.

Since the light-emitting diodes 136 are a heat-generating element, to improve heat dissipation and therefore elongate lifetime of the light source circuit board 130, the base 110 may further include a plurality of heat dissipation fins 114, wherein the heat dissipation fins 114 and the circuit board accommodating recess 112 are disposed at opposite sides of the base 110, such that heat dissipation of the light source circuit board 130 contacting the base 110 is improved.

It should be noted that using none, one, or both of the heat dissipation pad 180 and the heat dissipation fins 114 is determined by the practical needs. For people having ordinary skill in the art, using the heat dissipation pad 180 and the heat dissipation fins 114 or not influences the overall heat dissipation of the illuminating device 100.

In addition, the illuminating device 100 further includes a pivot mask 190, wherein the base 110 is configured to the pivot mask 190, and the pivot mask 190 surrounds outside of the base 110. The pivot mask 190 is approximately in a U shape, and the pivot mask 190 may be located on a lamp base fixed to a ceiling, a wall, or a portable lamp. In addition, an angle of the pivot mask 190 relative to a fixed point may be adjusted to adjust an illuminating range of the illuminating device 100.

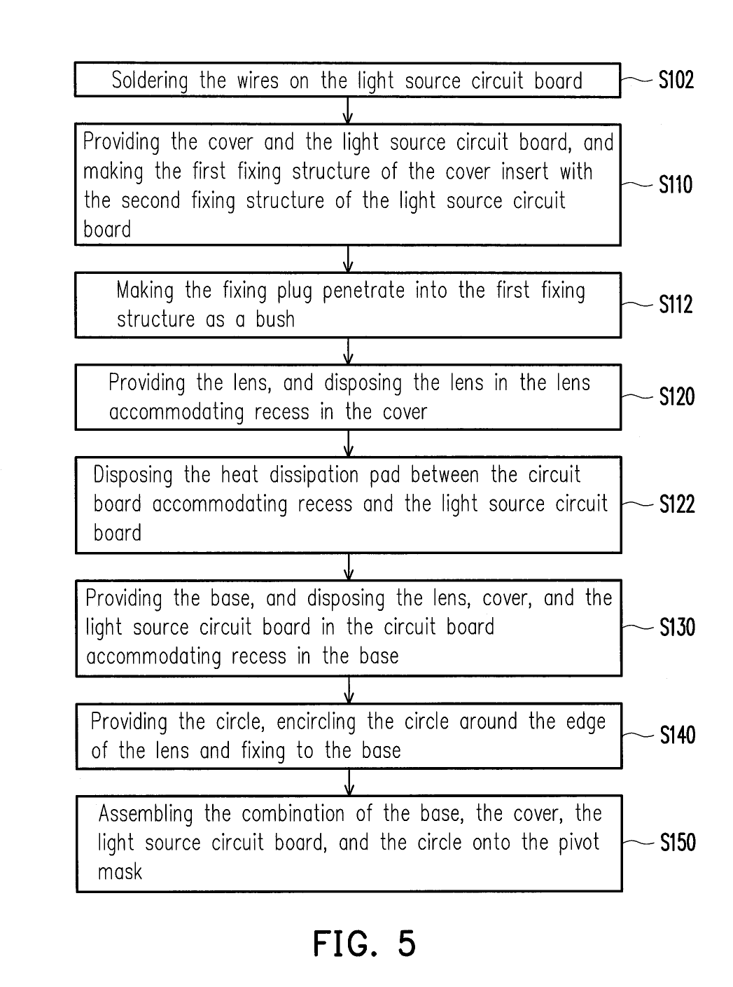

FIG. 5 is a flowchart of fabrication of the illuminating device of FIG. 1. Referring to FIGS. 1 and 5 together, fabrication of the illuminating device 100 of the embodiment above includes: step S110, providing the cover 120 and the light source circuit board 130 and inserting the first fixing structure 124 of the cover 120 with the second fixing structure 132 of the light source circuit board 130 to assemble the first fixing structure 124 of the cover 120 and the second fixing structure 132 of the light source circuit board 130 together; step S120, providing the lens 140 and disposing the lens 140 in the lens accommodating recess 122 of the cover 120; step S130, providing the base 110 and disposing the lens 140, cover 120, and the light source circuit board 130 in the circuit board accommodating recess 112 of the base; step S140, providing the circle 150, making the circle 150 encircle the edge of the lens 140, and buckling to the base, such that the lens 140, the cover 120, and the light source circuit board 130 are fixed in the circuit board accommodating recess 112 of the base. The steps above approximately complete fabrication of the illuminating device 100.

Before assembling the light source circuit board 130 and the cover 120, the wires 138 are soldered to the light source circuit board 130, as shown in step S102. In addition, assembling of the lens 140 and the cover 120 is to dispose the elastic arm locking hooks 129 at the edge of the cover 120, and when the lens 140 is disposed in the lens accommodating recess 122 of the cover 120, the elastic arm locking hooks 129 disposed outside of the lens accommodating recess 122 fasten the lens 140. Thereby the lens 140 is fixed relative to the cover 120.

Furthermore, at step S110, the first fixing structure 124 as a bush correspondingly penetrates into the second fixing structure 132 as a through-hole, such that the cover 120 is inserted with the light source circuit board 130 to be assembled together. After step S110, the fixing plug 160 is made penetrate into the first fixing structure 124 as a bush, as shown in step S112. The effect that the fixing plug 160 is made penetrate into a bush has been explicated above and will not be further described herein. Moreover, before step S130, the heat dissipation pad 180 is further disposed between the circuit board accommodating recess 112 and the light source circuit board 130, as shown in step S122.

Afterward, as shown in step S150, the base 110, the cover 120, the light source circuit board 130, the lens 140, and the circle 150 are assembled onto the pivot mask 190.

It can be known from the above that the steps of fabrication of the illuminating device 100 described in the embodiment are different from the steps of fabrication of the conventional illuminating devices. The difference results from that the illuminating device 100 described in the embodiment has a structure different from the conventional illuminating devices. Therefore, an adaptive adjustment of fabrication is necessary.

In view of the above, in the illuminating device of the embodiment of the disclosure, fixing structures are separately disposed for the light source circuit board 130 and the cover 120, and the fixing structures are inserted together to fix the light source circuit board 130 and the cover 120 together. Relatively, the light source circuit board 130 and the cover 120 of the conventional illuminating devices are not disposed with a fixing structure, so it is necessary to use another element, such as a frame or a screw to fix the light source circuit board 130 and the cover 120 together. The illuminating device of the embodiment of the disclosure thus has a completely different configuration from the conventional illuminating devices.

In addition, the material of the fixing structure of the cover 120 is chosen to be a non-conductive material, such that the creepage distance of the illuminating device when being applied with high voltage is increased, thereby improving tolerance of the illuminating device to high voltage.

Moreover, the fixing plug 160 penetrating into the bush allows the bush to be kept in an open state, such that the light source circuit board 130 and the cover 120 are more firmly assembled.

Furthermore, the budge portion 128 is disposed to increase length of the fixing structures as well as containing the wires 138, which are connected to the external power source to provide power to the light-emitting diodes 136, in the budge portion 128, thereby improving a sense of simplicity in appearance for the illuminating device.

Besides, the disposition of the heat dissipation pad 180 and the heat dissipation fins 114 improves the overall heat dissipation of the illuminating device and elongates the lifetime of the illuminating device.

Since the structure of the illuminating device in the embodiment is different from the structure of the conventional illuminating devices, the fabrication of the illuminating device of the embodiment is also adaptively adjusted in terms of the steps of fabrication, such that the fabrication of the illuminating device in the embodiment maintains smooth.

Although the invention has been disclosed by the above embodiments, they are not intended to limit the invention. It will be apparent to those of ordinary skill in the art that modifications and variations to the invention may be made without departing from the spirit and the scope of the invention. Accordingly, the protection scope of the invention falls in the appended claims.

What is claimed is:

1. An illuminating device, comprising:
a base, comprising a circuit board accommodating recess;
a cover, assembled to the base and located in the circuit board accommodating recess, the cover having a lens accommodating recess and a first fixing structure located at opposite sides;
a light source circuit board, disposed in the circuit board accommodating recess and between the cover and the base, the light source circuit board having a second fixing structure inserted with the first fixing structure, such that the light source circuit board and the cover are fixed together;
a lens, disposed in the lens accommodating recess; and
a circle, encircling an edge of the lens and fixing to the base.

2. The illuminating device as claimed in claim 1, wherein the first fixing structure is a through-hole, whereas the second fixing structure is a bush, and the bush is correspondingly latched into the through-hole.

3. The illuminating device as claimed in claim 2, wherein the bush is formed of two locking hooks.

4. The illuminating device as claimed in claim 2, further comprising a fixing plug penetrated into the bush.

5. The illuminating device as claimed in claim 1, wherein the light source circuit board comprises:
a circuit board, the second fixing structure being disposed in the circuit board; and
a plurality of light-emitting diodes, disposed on a surface of the circuit board facing the lens.

6. The illuminating device as claimed in claim 5, wherein the circuit board is in a round shape, and the light-emitting diodes are arranged along a circumferential direction of the circuit board.

7. The illuminating device as claimed in claim 5, wherein the cover further comprises a plurality of accommodating holes, and the light-emitting diodes penetrate through the accommodating holes.

8. The illuminating device as claimed in claim 7, wherein the cover further comprises a budge portion, located in the lens accommodating recess and budging toward the lens, and the accommodating holes are disposed around the budge portion.

9. The illuminating device as claimed in claim 8, wherein the second fixing structure is correspondingly located at a side of the budge portion away from the lens.

10. The illuminating device as claimed in claim 5, wherein the light source circuit board further comprises two wires connected to the light source circuit board, and the light-emitting diodes are electrically connected with the wires through the light source circuit board.

11. The illuminating device as claimed in claim 10, wherein a bottom of the cover further comprises a circular structure, and the circular structure surrounds outside of the light source circuit board.

12. The illuminating device as claimed in claim 11, wherein the circular structure of the lens accommodating recess of the cover has an exit, and the wires extend outside through the exit.

13. The illuminating device as claimed in claim 8, wherein the light source circuit board further comprises two wires connected to the circuit board, and wires are contained in the budge portion.

14. The illuminating device as claimed in claim 13, wherein a bottom of the cover further comprises a circular structure, and the circular structure surrounds outside of the light source circuit board.

15. The illuminating device as claimed in claim 14, wherein the circular structure of the lens accommodating recess of the cover has an exit connected with the budge portion, and the wires extend outside through the exit.

16. The illuminating device as claimed in claim 1, wherein the cover further comprises a plurality of elastic arm locking hooks disposed along an edge of the cover and fastening the lens.

17. The illuminating device as claimed in claim 1, further comprising a plurality of fixing members, whereas the cover comprises a plurality of fixing structures, and the fixing members penetrate through the fixing structures to lock into the base.

18. The illuminating device as claimed in claim 1, further comprising a heat dissipation pad disposed between the base and the light source circuit board and located in the circuit board accommodating recess.

19. The illuminating device as claimed in claim 1, wherein the base further comprises a plurality of heat dissipation fins, the heat dissipation fins and the circuit board accommodating recess being located at opposite sides of the bottom.

20. The illuminating device as claimed in claim 1, further comprising a pivot mask, the base being assembled to the pivot mask, and the pivot mask surrounding outside of the base.

21. The illuminating device as claimed in claim 1, wherein a material of the second fixing structure is a non-conductive material.

22. The illuminating device as claimed in claim 1, wherein a bottom of the cover further comprises a circular structure, and the circular structure surrounds outside of the light source circuit board.

23. A method of fabricating an illuminating device, comprising:
providing a cover and a light source circuit board and inserting a first fixing structure of the cover with a second fixing structure of the light source circuit board to assemble the first fixing structure of the cover and the second fixing structure of the light source circuit board together;
providing a lens, and disposing the lens in a lens accommodating recess of the cover;
providing a base, and disposing the lens, the cover, and the light source circuit board in a circuit board accommodating recess of the base; and
providing a circle, making the circle encircle an edge of the lens and fixing to the base, such that the lens, the cover, and the light source circuit board are fixed to the circuit board accommodating recess of the base.

24. The method of fabricating the illuminating device as claimed in claim 23, further comprising soldering two wires on the light source circuit board before assembling the light source circuit board and the cover together.

25. The method of fabricating the illuminating device as claimed in claim 23, wherein assembling the lens and the cover together is to form a plurality of elastic arm locking hooks at an edge of the cover to fasten the lens.

26. The method of fabricating the illuminating device as claimed in claim 23, wherein inserting the first fixing structure with the second fixing structure to assemble the first fixing structure and the second fixing structure together is to make the first fixing structure a bush and the second fixing structure a through-hole, the bush correspondingly penetrating into the through-hole.

27. The method of fabricating the illuminating device as claimed in claim 26, further comprising making a fixing plug penetrate into the bush.

28. The method of fabricating the illuminating device as claimed in claim 23, further comprising disposing a heat dissipation pad between the circuit board accommodating recess and the light source circuit board before disposing the lens, the cover, and the light source circuit board in the circuit board accommodating recess of the base.
